(19) United States
(12) Patent Application Publication
(10) Pub. No.: US 2009/0276801 A1
(43) Pub. Date: Nov. 5, 2009

(54) METHOD AND SYSTEM FOR CUSTOMIZING INFORMATION

(76) Inventor: David Wayne Reece, Harrisonville, MO (US)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(21) Appl. No.: 12/112,674

(22) Filed: Apr. 30, 2008

(51) Int. Cl. H04H 60/35; H04N 7/173

(52) U.S. Cl. 725/14; 725/115

(57) ABSTRACT

A method for customizing information is provided. The method monitors electronic activities through a communication link coupling a consumer system and a service provider, the consumer system including a plurality of communication devices. The method determines in response to the monitoring which of the plurality of communication devices are operating and collects activity information indicative of activities of each of a plurality of consumers in accessing electronic content through one or more of the communication devices. The method associates the collected activity information corresponding to each of the plurality of consumers with one of the plurality of activity profiles maintained in a database. The method also customizes information in response to the plurality of associated activity profiles for delivery to corresponding consumers

### FIELD OF THE INVENTION

The present invention relates, generally, to communication networks and, more particularly, to a method and a system for customizing information based on tracked activities of consumers.

### BACKGROUND OF THE INVENTION

In the digital age, consumers are exposed to different types of advertising, both explicitly and subtly, in an increasingly higher volume. To understand consumers' needs and wants, advertisers and media firms need to know where their targeted audience or consumers are and how they interact with different media content. This targeted audience is highly fragmented, and the conventional tracking approaches that media firms have relied on are becoming less precise and even prone to error.

Television audience and particularly consumers with digital cable or satellite TV services have access to an amazing number of channels to choose from. Moreover, these consumers can also watch TV online, from digital video recorder (DVR) boxes, on mobile phones, or on video iPods. To track the viewing habits of these consumers, media firms and advertisers generally rely on Nielsen's data, which is not typically representative of the overall viewing patterns on a national scale. Moreover, Nielsen's People Meter, an electronic measuring device, requires viewers to manually push a button for group size identification so Nielsen can link a TV program watched to viewing consumers.

Consumers have become experts at locating and tuning to desirable programs but also at tuning out or even turning off intrusive, irrelevant, and unentertaining ads. In the digital age, relevancy has become a necessary attribute of an effective ad because consumers are just one click away from turning off irrelevant ones.

Unlike traditional media, the Internet can provide precise traffic data to advertisers on a usage basis. Every ad response generated, link clicked, or keyword entered can be recorded on a server, and data collected can be dissected and analyzed for consumer behaviors as desired by advertisers. With this level of analysis, the Internet has easily attracted advertisers and enjoys the fastest advertising revenue growth. Internet giants, such as Google and Yahoo!, have demonstrated the Web's usefulness as a viable advertising vehicle. So, getting consumers motivated to visit a Website has become part of advertising strategies. However, placing “pop-up” advertisements or other intrusive advertising on consumers' screens has also generated tuning out reactions from the targeted consumers.

Therefore, there is a need for a method and system for delivering electronic information, such as advertisements, to viewing individual consumers or groups of consumers, which is customized based on their monitored electronic activities collected from a plurality of communication types.

### SUMMARY OF THE INVENTION

A technical advance is achieved by one or more embodiments, methods, systems and articles of manufacture implemented according to teaching of the present invention, which provide customization and delivery of information to viewing customers based on their tracked behaviors or activities.

In one embodiment of the present invention, a method for customizing information is provided. The method monitors electronic activities through a communication link coupling a consumer system and a service provider, the consumer system including a plurality of communication devices. The method determines in response to the monitoring which of the plurality of communication devices are operating and collects activity information indicative of activities of each of a plurality of consumers in accessing electronic content through one or more of the communication devices. The method associates the collected activity information corresponding to each of the plurality of consumers with one of the plurality of activity profiles maintained in a database. The method also customizes information in response to the plurality of associated activity profiles for delivery to corresponding consumers.

In another embodiment of the present invention, a system for customizing information is provided. The system comprises a communication unit, activity analyzing unit and an information delivery unit operatively coupled to one another and configured to execute the above noted method steps.

In another embodiment of the present invention, a computer-readable medium contains a program adapted to cause a data processing system to execute the above-noted method steps. In this regard, the computer-readable medium may be a computer-readable medium, such as solid-state memory, magnetic memory such as a magnetic disk, optical memory such as an optical disk, or a computer-readable transmission medium, such as a modulated wave (such as radio frequency, audio frequency or optical frequency modulated waves) or a modulated downloadable bit stream that can be received by a computer via a network or a via a wireless connection.

Other systems, methods, features, and advantages of the present invention will be or will become apparent to one with skill in the art upon examination of the following figures and detailed description. It is intended that all such additional systems, methods, features, and advantages be included within this description, be within the scope of the invention, and be protected by the accompanying claims.

### BRIEF DESCRIPTION OF THE DRAWINGS

The accompanying drawings, which are incorporated in and constitute a part of this specification, illustrate embodiments of the present invention. In the drawings:

FIG. 1 is a block diagram illustrating an embodiment of a communication system in accordance with the present invention;

FIG. 2 is block diagram illustrating an embodiment of a consumer management system configured for customizing and delivering information to consumers in accordance with the present invention; and

FIG. 3 is a flow diagram of an embodiment of a process for customizing and delivering information to consumers in accordance with the present invention.

### DETAILED DESCRIPTION OF THE PRESENTLY PREFERRED EMBODIMENTS

Reference will now be made in detail to embodiments consistent with the present invention as illustrated in the accompanying drawings. Wherever possible, the same reference numbers will be used throughout the drawings and the following description to refer to the same or like parts. As would be understood to one of ordinary skill in the art, certain components or elements for customizing information delivery to targeted customers are not shown in the figures or specifically noted herein to avoid obscuring the invention.

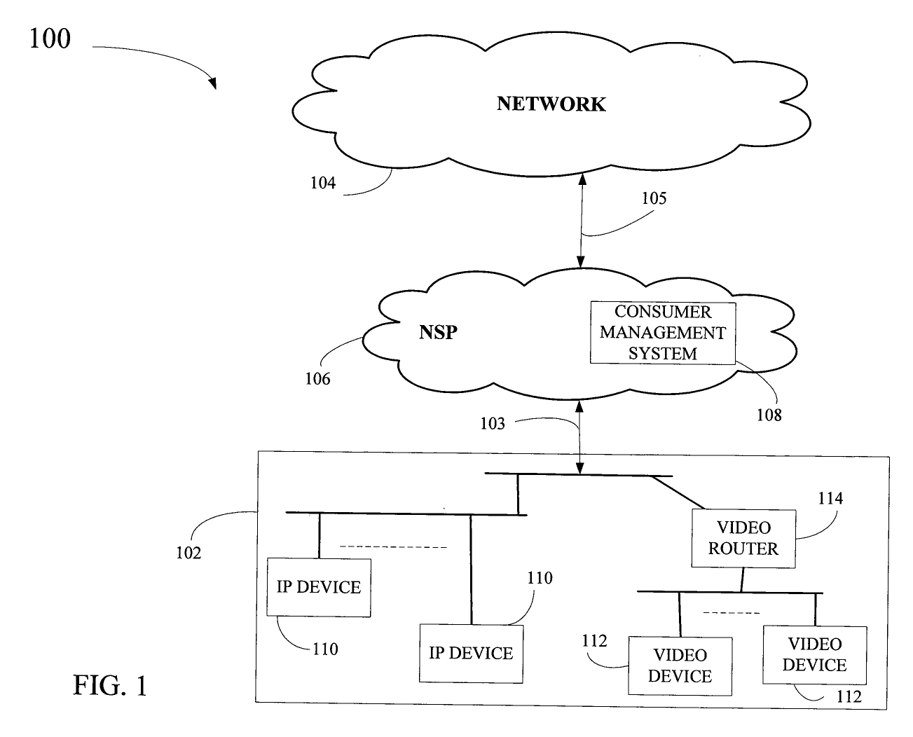

Referring to FIG. 1, a schematic diagram is shown illustrating one embodiment of a communication system 100. The communication system 100 includes a subscriber or consumer system 102 connected to a communication network 104, such as the Internet, via an network Service Provider (NSP) 106. The NSP 106 implements switches, routers, and/or other network equipment to provide its consumers with access to the Internet 104. The NSP 106 includes a consumer management system 108 that serves to manage certain communication or access operations, services and accounting related to the consumer system 102. The consumer system 102 may include a plurality of Internet Protocol (IP) devices 110 and a plurality of video viewing devices 112. Although referred to herein as IP devices 110, IP devices may be any network devices capable of communicating data over a network, whether using the Internet protocol or any other suitable protocol.

Each of the IP devices 110 is recognized individually by a network address, such as an IP address. As it is well known, this network address is an address used by certain electronic devices in order to identify and communicate with each other on a computer network. Any participating network device—including routers, switches, computers, infrastructure servers (e.g., NTP, DNS, DHCP, SNMP, etc.), printers, fax machines, and some telephones—can have its own address that is unique within the scope of the specific network. Some network addresses are intended to be unique within the scope of the global Internet, while others need to be unique only within the scope of an enterprise. The network address acts as a locator for one network device to find another and interact with it. It is not intended, however, to act as an identifier that always uniquely identifies a particular device. In current practice, a network address is not always a unique identifier, due to technologies such as dynamic assignment and network address translation. Network addresses are managed and created by the Internet Assigned Numbers Authority (IANA). The IANA generally allocates super-blocks to Regional Internet Registries, who in turn allocate smaller blocks to NSPs and enterprises.

Although many consumer systems 102 may be connected to the network 104 via a corresponding plurality of NSPs 106, only one NSP and one consumer system are shown in FIG. 1 to avoid overly complicating the drawing. It should therefore be appreciated that the communication system 100 of FIG. 1, as well as the contents of the other drawings, are intended solely for illustrative purposes, and that the present invention is in no way limited to the particular example embodiments shown in the drawings and described herein.

In one embodiment, both the IP devices 110 and the video devices 112 are communication devices through which a consumer or a group of consumers can exchange communication traffic with the NSP 106, and thus access electronic content, services, and/or other functions supported in the NSP 106 or in the network 104. The IP device 110 may be a personal computer with a modem, although other types including fixed, portable, or mobile devices are also contemplated. The video device 112, which may be any video apparatus capable of displaying downstream video content, is connected directly to the NSP 106 or through a home communication terminal known as a set-top box (STB) 114. The STB 114 can also be a computing device for accessing content services and navigating the consumer through a maze of available services. In addition to potentially supporting traditional analog broadcast video functionality, digital STBs may support an increasing number of two-way digital services such as video-on-demand, personal video recording (PVR), and digital video recording (DVR). In support of the functionality of the STB 114, the NSP 106 may provide an Internet Protocol TV (IPTV) service as a source of electronic information or content, by servers or other systems within or connected to the network 104. The STB 114 can distribute multiple streams of video content to enable viewing of different content on the individual video devices 112.

In one embodiment, the consumer system 102 is an Internet service subscriber or consumer, or more generally a subscriber to a service offered by the NSP 106. Any of various physical access mechanisms could be used by the consumer system 102 and supported by the NSP 106 to establish a communication link 103, including digital subscriber line (DSL), cable modem, dialup, fiber connection, local area network access, or any other physical access means. The consumer system 102 is typically a household, business, hotel, or other facility, comprised of a number of individuals or users that typically access the Internet via the IP devices 110 and view downstream videos on the video devices 112. One advantage of certain embodiments of the invention is that no changes at consumer systems are necessary. That is, consumer systems 102 need not be subjected to any modifications to support activity monitoring, or other functions, in accordance with an embodiment of the present invention.

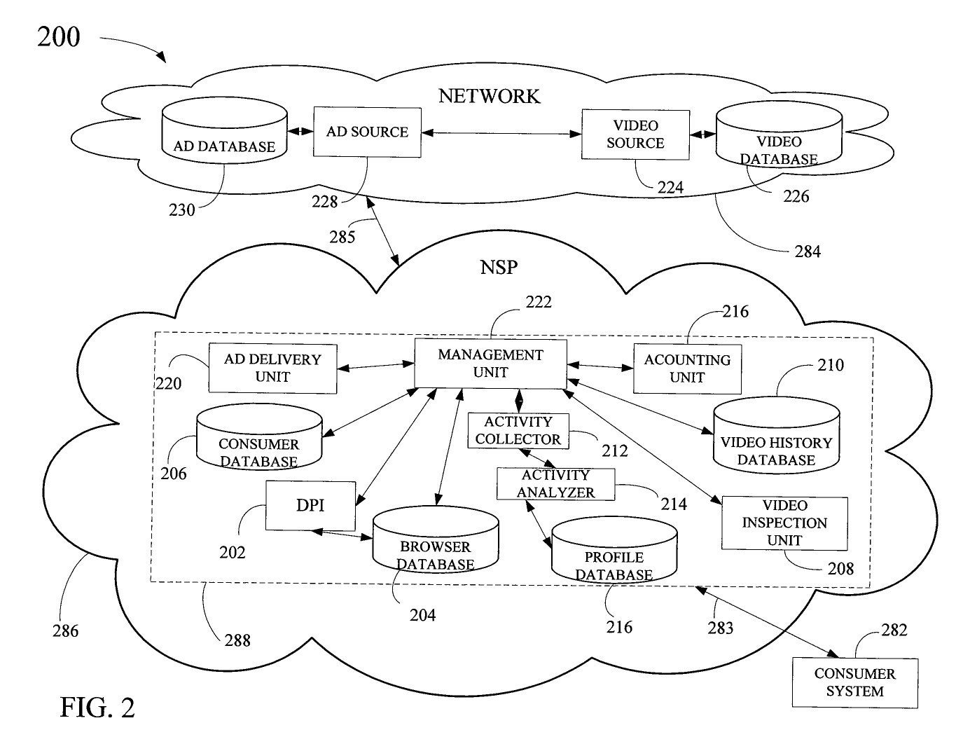

Now referring to FIG. 2, a block diagram 200 illustrating one embodiment of the consumer management system 288 configured for customizing and delivering information to targeted or designated consumers is shown. The consumer management system 288 may be integral to the NSP 286 and be operatively connected to a consumer system 282 and to a network 284 via corresponding communication links 283 and 285. The consumer management system 288 may include a management unit 201, a deep packet inspection (DPI) unit 202, a browser history database unit 204, a consumer information database unit 206, a video analyzing or inspection unit 208, a video history database unit 210, an activity or behavioral collecting unit 212, an activity analyzer unit 214, a profile or category database unit 216, an accounting unit 218, and an ad/information delivery unit 220. Additionally, the consumer management system 288 is coupled via communication links 285 to a video source 224 that is connected to and maintains a video database 226, and to an information or advertisement (ad) source 228 that is connected to and maintains an ad database 230.

Another embodiment of the consumer management system 288 may adopt fewer processing units, without impacting the intended functionality consistent with the present invention. It should be understood that various aspects of the present application may be used together as would occur to one of ordinary skill in the art without utilizing all of the units thereof. Moreover, it should be apparent that additional units can be developed without departing from the spirit and scope of the present invention. The units of the consumer management system 288 and the interconnections linking them may be implemented in any of various ways. For example, each unit may be implemented in hardware, software, firmware, or combinations thereof. The units are generally in communication with the management unit 201, but may be connected directly to one another as dictated by their functions. Local connections may be implemented via physical cables or conductors and/or logical couplings through commonly accessed variables or memory areas where units are implemented in the same equipment, such as on one computer or network device. Longer range connections such as wired or wireless network connections may be used to couple remote units together for operation.

The management unit 201 may provide consumer management functions, which might include authentication, authorization, accounting, policy enforcement, addressing control, etc. The management unit 201 may be configured to manage and monitor consumer information that can be stored in and retrieved from the consumer information database 206. The management unit 201 may be implemented in a remote access server (RAS) or the like. Additionally, although only one management unit 201 is shown, a larger number of management units may be required to meet the needs of a potentially large and decentralized consumer base served by a network service provider.

As well-known to one of ordinary skill in the art, the DPI unit 202 is a form of a computer network packet filtering unit that examines the data and/or header part of a communication packet as it passes through an inspection point. DPI enables advanced security functions as well as internet data mining. The DPI unit 202 is typically provided “inline” in the communication link 283 between the consumer system 282 and the NSP 286, and may also be provided in an “offline” position (not shown), operatively coupled to the communication link 283 but not itself part of that link.

The DPI unit 202 is configured, whether provided at an inline position or an offline position, to monitor all communication traffic flows of the consumer system 282 from and to the IP devices 110. The DPI monitoring is performed by interrogating a header and payload of a packet comprising a message or electronic content, and determining data protocol structures, content type, content source, content title, key words in content, video frame recognition, and so forth. That is, DPI enables identification and classification of the content based on information extracted from the data part of the packet.

Activity or behavioral information indicative of consumer activities in accessing the network 284 is collected from at least some of the monitored communication activities. By operatively coupling the DPI unit 202 to the communication link 283, all traffic or activities of members or users operating the IP devices 110 and the video devices 112 can be monitored.

The browser history database 204 is coupled indirectly to the DPI unit 202 through the management unit 222, and configured to collect and store activity or behavioral information indicative of consumer activities in accessing the network 284 from at least some of the communication traffic monitored by the DPI unit 202 and their corresponding timestamps. Although all consumer traffic could potentially be used to collect activity information, this activity information need not necessarily be collected from all of the traffic. The browser history database 204 can be structured to store a consumer's or groups of consumers' behavior in terms of their activities, day and time of their activities, recency and frequency of relevant typed keywords, and so forth.

The consumer information database unit 206 is a database that includes all personal data related to each individual consumer system 282 provided at the stage of initial subscription for service from the NSP 286, and updated from time to time based on requested or promoted service changes, for example. The consumer information database unit 206 is populated during initial system configuration and timely updated to add new consumers or to remove consumers that cancel their network services.

The video analyzing or inspection unit 208 is typically provided “inline” in the communication link 283 between the consumer 282 and the NSP 286, and may also be provided in an “offline” position (not shown), operatively coupled to the communication link 283 but not itself part of that link. The video inspection unit 208 is configured, whether provided at an inline position or an offline position, to monitor all communication traffic flows of the consumer 282 from and to, for example, with respect to FIG. 1, the STB 114 or directly from and to the video devices 112. The video requests initiated by a member of the consumer system 282 from each of the video devices 112 is monitored and communicated to the video history database 210 for storage. Moreover, the video history database 210 is configured to organize video request and viewing information, based on topics and genre of videos, ratings of the videos, corresponding viewing timestamps, and other useful viewing attributes. This video information may help further determine demographics of the members of the consumer system 282.

The activity or behavioral collecting unit 212 is configured to tap or poll the DPI unit 202, the browser history database 204, the video analyzing unit 208 and the video history database 210 to look for and collect activity information, such as contexts of web destinations, online activity patterns, search interests, video interests and other online activity patterns.

Collected activity information is communicated to the activity analyzer 214 for every online transaction, which could be a transaction like a webpage URL, a group of search transactions, and a single video request and viewing. As such, the collected activity information comprises combination of activities of the different members operating the multitude of IP devices 110 and video devices 112, as well as potentially other electronic devices, such as network or IP phones, which can be in data communication through the communication link 283. In one embodiment, the different members may be elements of a household, such as parents and kids, or employees of an enterprise.

The activity analyzer 214 then filters the collected activity information, associates it with each individual consumer or a group of consumers from the consumer system 282 and corresponding timestamps, formulates profiles or categories of the consumers based on their activities and behaviors, and communicates the results to the profile database 216 for storage. The different consumer or activity profiles may include at least gender categories, age categories, combined gender and age categories, and demographic categories. Additional sub-categories can also be developed such as for music, entertainment, sports, politics, education, shopping, and other interests.

The activity analyzer 214 is configured to communicate the activity profiles to the information or ad delivery unit 220. Based on these activity profiles, the ad delivery unit 220 can match targeted or customized information or ads to corresponding individual consumers or groups of consumers during their online activities, such as surfing the Internet or viewing videos. Alternately, the ad delivery unit 220 might instead poll the activity analyzer 214 for consumer indicators or access the activity profiles in the database 216. The ad delivery unit 220 is responsible for controlling or managing the delivery of customized information, which could be the most relevant ads, to the consumer.

The ad delivery unit 220 is illustratively coupled to the accounting unit 218 via the management unit 222, but may be instead coupled directly to one another. The accounting unit 218 may be operatively coupled to one or more ad sources 228 and to one or more video sources 224. The accounting unit 218 processes billing that is generally dependent only upon information delivery. The ad delivery unit 220 typically provides a delivery indication to the accounting unit 218 when customizing information is delivered to the consumer system 282.

The video source 224 may be a video content provider, an information publisher, and the like. Alternately, the video source 224, which is coupled to a video storage or database 226, may be integral to the NSP 286, which provides an IPTV service, for example. Another function of the video source 224 may be to provide information spaces or timeslots in their video content for inserting customized information, such as ads. The video source 224 is coupled to a source of customized information 228, which is connected to the ad database 230. A media firm or an advertiser, which may be a provider of customized information, may promote products to the users of the consumer system 282, through online advertising. The customized information is typically presented to a consumer via a display screen or other output device, with or embedded in video content from video sources or other Internet portals or WebPages.

The ad delivery scheme or process may involve a few processing steps, in that the customized information stored in the ad database 230 is provided to the video source 224, which in turn delivers it to the consumer system 282 with other video content being sent. Alternately, customized information may be sent directly from the ad delivery unit 220 to the consumers in the consumer system 282.

The browser history database unit 204, the consumer information database unit 206, the video history database unit 210, and the profile database unit 216 can each comprise any type of storage including magnetic or optical drives, a local drive or a network drive, and a floppy disk, hard drive, CD-ROM, DVD-ROM, DVD-RAM, a tape drive, and the like. Each of these databases is illustrated to be stored in a respective different memory device, but may be altogether stored in a single memory device.

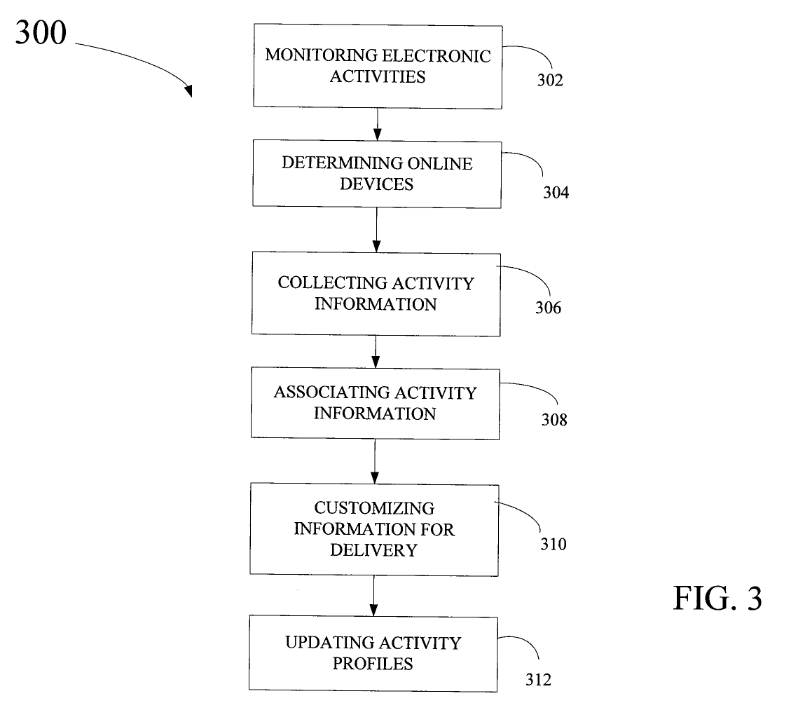

Now referring to FIG. 3, a flow diagram 300 illustrates a method for customizing information delivery to a plurality of consumers. At step 302, electronic activities through a communication link coupling a consumer system and a network service provider are monitored. The monitored electronic activities can be generated by a plurality of consumers, each operating one or more of the network devices located within the single consumer system. Based on or in response to this monitoring, a determination is made as to which of the network devices operating within the consumer system are online, at step 304. Subsequently, activity information indicative of activities of each of the plurality of consumers in accessing electronic content through one or more of the online devices is collected, at step 306. The collected activity information is analyzed and may be combined from multiple devices for association with one of a plurality of activity profiles maintained in a database accessed by the service provider, at step 308.

In one embodiment, importantly, based on the device being accessed and the collected activity information, a determination can be made as to which particular consumer or subgroup of consumers is accessing the device. For example, in response to the device being monitored, (for example, a television), the time of day, and the television channel or television show, it may be determined that a child in general, or a particular child more specifically is associated with the activity information. Alternatively, a father or adult male may be identified based on similar information. Alternatively, exact identification of an individual may be difficult but a determination may be made that it is at least a subgroup of a consumer group such as, for example, a determination that a user of a device is a child or a parent. Identifying the particular consumer or family member may be important both in selecting which activity profile is updated and what activity profile is used to customize information such as an advertisement for delivery to the individual consumer. Thus, advertising previously conducted by customer account, household, or other consumer group may instead be specifically targeted to a specific device being used by a particular individual within a consumer group during times when the specific device is being used by such individual.

Each of the plurality of activity profiles is maintained to represent a profile or behavior of one of the consumers operating the network devices. For example, you may have a profile for each member of a family. Alternatively or additionally, you may have a profile for adults in the family, teenagers in the family, and younger children in the family. Based on the associated activity profile, information is customized for delivery to each of the consumers for presentation with the accessed electronic content on the associated online device or devices when such consumer is used the device or devices, at step 310. That is, the customized information may be inserted or embedded at appropriate information spaces in the IPTV content or in the accessed IP content. Alternately, the customized information may be flashed on or superimposed over the accessed electronic content. At step 312, the collected activity information is used to update the plurality of activity profiles in the database, at step 312.

While various embodiments of the present invention have been described, it will be apparent to those of skill in the art that many more embodiments and implementations are possible that are within the scope of this invention. Accordingly, the present invention is not to be restricted except in light of the attached claims and their equivalents.

1. A method for customizing information, comprising:
monitoring electronic activities through a communication link, the communication link operable to communicate data between a consumer system and a service provider, the consumer system including a plurality of communication devices;
determining in response to the monitoring which of the plurality of communication devices are operating;
collecting activity information indicative of activities of each of a plurality of consumers in accessing electronic content through one or more of the plurality of communication devices;
associating the collected activity information corresponding to each of the plurality of consumers with one of a plurality of activity profiles maintained in a database; and
customizing information in response to the plurality of associated activity profiles for delivery to corresponding consumers.

2. The method of claim 1, wherein the monitoring comprises performing a deep packet inspection of packets communicated though the communication link.

3. The method of claim 2, wherein the deep packet inspection comprises interrogating header, payload, content, title of the inspected packets.

4. The method of claim 1, wherein collecting activity information comprises aggregating activity information from different communication devices.

5. The method of claim 4, wherein the different communication devices comprise a personal computer, a television, and a web phone.

6. The method of claim 1, wherein the customizing information is delivered with the accessed electronic content and presented on or more of the associated communication devices.

7. The method of claim 1, further comprising:
updating the plurality of activity profiles in the database using the collected activity information.

8. The method of claim 1, wherein the customized information is selected from information provided by a plurality of information providers.

9. The method of claim 1, wherein the customized information comprises an advertisement.

10. The method of claim 1, wherein the accesses electronic content is a video content.

11. A system for customizing information, comprising:
a communication unit that monitors electronic activities through a communication link, the communication link operable to communicate data between a consumer system and a service provider, the consumer system including a plurality of communication devices, determines in response on the monitoring which of the plurality of communication devices are operating, and collects activity information indicative of activities of each of a plurality of consumers in accessing electronic content through one or more of the communication devices;
an activity analyzer that associates the collected activity information corresponding to each of the plurality of consumers with one of a plurality of activity profiles maintained in a database, and customizes information in response to the associated activity profiles; and
an information delivery unit that delivers to each of the plurality of the consumers the corresponding customized information.

12. The system of claim 11, wherein the monitoring comprises performing a deep packet inspection of packets communicated though the communication link.

13. The system of claim 11, wherein the deep packet inspection comprises interrogating header, payload, content, title of the inspected packets.

14. The system of claim 11, wherein collecting activity information comprises aggregating activity information from different communication devices.

15. The method of claim 14, wherein the different communication devices comprise a personal computer, a television, and a web phone.

16. The system of claim 11, wherein the customizing information is delivered with the accessed electronic content and presented on or more of the associated communication devices.

17. The system of claim 11, wherein the activity analyzer updates the plurality of activity profiles in the database using the collected activity information.

18. The system of claim 11, wherein the activity analyzer selects the customized information from information provided by a plurality of information providers.

19. The system of claim 11, wherein the customized information comprises an advertisement.

20. The system of claim 11, wherein the accesses electronic content is a video content.

21. A computer-readable medium containing a computer program adapted to cause a computer to execute a method for customizing information, comprising:
monitoring electronic activities through a communication link, the communication link operable to communicate data between a consumer system and a service provider, the consumer system including a plurality of communication devices;
determining in response to the monitoring which of the plurality of communication devices are operating;
collecting activity information indicative of activities of each of a plurality of consumers in accessing electronic content through one or more of the plurality of communication devices;
associating the collected activity information corresponding to each of the plurality of consumers with one of a plurality of activity profiles maintained in a database; and
customizing information in response to the plurality of associated activity profiles for delivery to corresponding consumers.
